(19) United States
(12) Patent Application Publication
(10) Pub. No.: US 2018/0114239 A1
(43) Pub. Date: Apr. 26, 2018

(54) METHODS, SYSTEMS, AND COMPUTER READABLE MEDIA FOR ELECTRONICALLY DETERMINING BROADBAND NETWORK SERVICE RATES IN A DESIGNATED AREA

(71) Applicant: MasterCard International Incorporated, Purchase, NY (US)

(72) Inventor: Rick Bernard Unnerstall, O'Fallon, MO (US)

(21) Appl. No.: 15/331,771

(22) Filed: Oct. 21, 2016

(51) Int. Cl. G06Q 30/02; G06Q 20/10

(52) U.S. Cl. CPC G06Q 30/0206; G06Q 20/102

(57) ABSTRACT

Methods, systems, and computer readable media for electronically determining broadband network service rates in a designated area are provided. An exemplary method includes filtering payment transaction data received from one or more payment transaction host servers to identify a plurality of payment transaction records corresponding to broadband network service provider entities. The method further includes determining, for each of the plurality of payment transaction records, broadband network service data including a customer location identifier, a broadband network service payment amount, and a broadband network service provider identifier and identifying broadband network service costs and availability within a designated geo-location utilizing at least the determined broadband network service data associated with the plurality of payment transaction records.

### TECHNICAL FIELD

The subject matter described herein relates to improved methods and systems for determining the availability and costs of broadband network services. More particularly, the subject matter described herein relates to systems, methods, and computer readable media for electronically determining broadband network service rates in a designated area.

### BACKGROUND

At present, the availability and cost associated with broadband network services can vary greatly based on the existing number of service providers and whether the broadband network service is deployed at a residential property or a commercial property. In particular, there significant inconsistencies of broadband network service costs can exist among broadband network service customer entities that reside within a common geo-location (e.g., same neighborhood, apartment building, condominium, office park, township, county, etc.), especially with respect to customers that are associated with businesses and/or commercial entities. In some instances, the lack of transparency with regard to actual broadband network service rates may prove to be problematic for the broadband customer entities who may be seeking impartial and affordable prices for broadband network services within a particular geo-location.

Accordingly, there exists a need for improved methods, systems, and computer readable media for electronically determining broadband network service rates in a designated area.

### SUMMARY

According to one aspect, the subject matter described herein relates to methods, systems, and computer readable media for electronically determining broadband network service rates in a designated area. An exemplary method includes filtering payment transaction data received from one or more payment transaction host servers to identify a plurality of payment transaction records corresponding to broadband network service provider entities. The method further includes determining, for each of the plurality of payment transaction records, broadband network service data including a customer location identifier, a broadband network service payment amount, and a broadband network service provider identifier and identifying broadband network service costs and availability within a designated geo-location utilizing at least the determined broadband network service data associated with the plurality of payment transaction records. The method also includes generating, and presenting, via a graphical user interface, a visual representation that indicates the broadband network service costs and availability within the designated geo-location.

The subject matter described herein may be implemented in hardware, software, firmware, or any combination thereof. As such, the terms “function”, “node”, or “module” as used herein refer to hardware, which may also include software and/or firmware components, for implementing the features being described. In one exemplary implementation, the subject matter described herein may be implemented using a non-transitory computer readable medium having stored thereon computer executable instructions that when executed by the processor and memory of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The subject matter described herein includes exchanging messages across a packet-based communications network, wherein the messages include payloads containing payment amount information, broadband network service provider identifiers, customer location identifiers, and/or any other broadband network service information associated with electronically determining broadband network service rates in a designated area. In some embodiments, facilitating the determination of broadband network service rates in a designated area includes invoking one or more application programming interfaces (APIs) configured to assist otherwise distinct applications with sharing data across a packet-based network.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating exemplary network architecture for electronically determining broadband network service rates in a designated area according to an embodiment of the subject matter described herein;

FIG. 2 is a diagram illustrating exemplary electronic messaging exchanged between various network entities for electronically determining broadband network service rates in a designated area according to an embodiment of the subject matter described herein;

FIG. 3 is a block diagram illustrating an exemplary broadband data monitoring (BDM) host server for electronically determining broadband network service rates in a designated area according to an embodiment of the subject matter described herein;

FIG. 4 is a flow diagram illustrating an exemplary method for electronically determining broadband network service rates in a designated area according to an embodiment of the subject matter described herein; and

FIG. 5 is a diagram illustrating an exemplary user interface display that may be used to electronically determine broadband network service rates in a designated area according to an embodiment of the subject matter described herein.

### DETAILED DESCRIPTION

In accordance with the subject matter disclosed herein, methods, systems, and computer readable media for electronically determining broadband network service rates in a designated area are provided. In some embodiments, the disclosed subject matter may be configured to determine actual broadband network service prices that have been paid and/or are being paid for each of a plurality properties/addresses located in a particular geo-location. Notably, check payments and payment card (e.g., credit card, debit card, etc.) payments comprise the primary methods of payment for broadband network services. By combining data sets including these various payment methods, the disclosed subject matter may be configured to determine the actual broadband network service prices for both residential and commercial properties located in a designated area. Further, the disclosed subject matter may leverage this information to determine trends, up-sell opportunities, and visualize the serviceability of the designated area across all existing broadband network service providers. By utilizing various data sources, the disclosed subject matter allows for a better understanding of the broadband network service marketplace and, thus, may uncover new opportunities for customers. Notably, this holistic view indicates the geographical areas in which broadband network service is available as well as the associated price points over a given time period.

Reference will now be made in detail to exemplary embodiments of the subject matter described herein, examples of which are illustrated in the accompanying drawings. Wherever possible, the same reference numbers will be used throughout the figures and refer to the same or like entities.

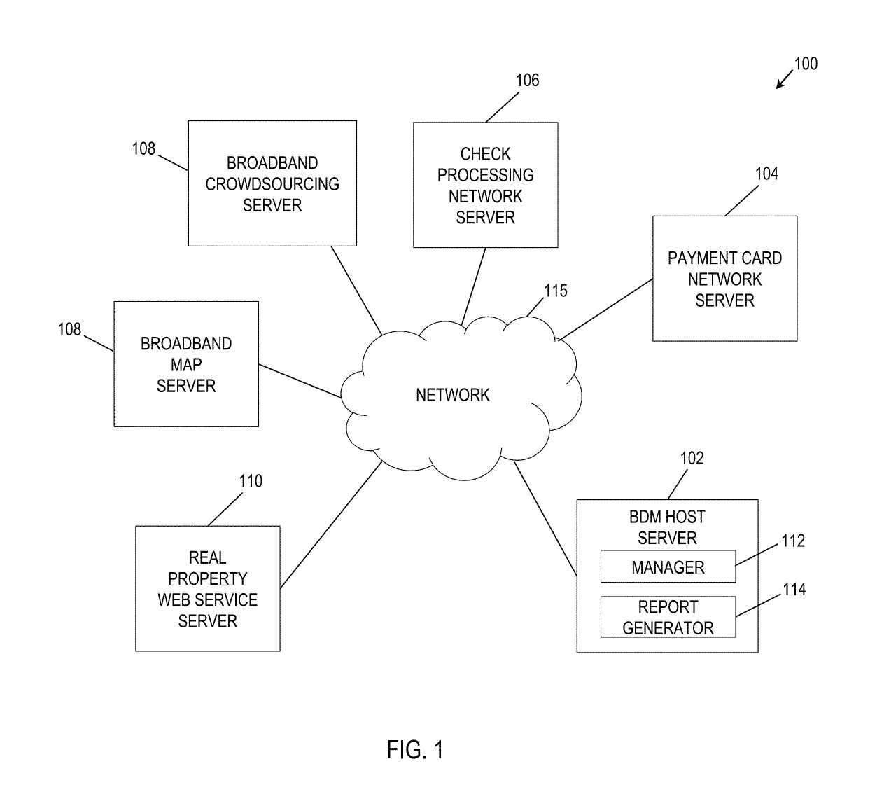

FIG. 1 is a schematic diagram illustrating an exemplary network environment or network system 100 associated with electronically determining broadband network service rates in a designated area according to an embodiment of the subject matter described herein. In some embodiments, system 100 includes different and/or distinct network nodes or entities for facilitating the determination of broadband network service price points in a designated area. For example, system 100 may include a broadband data monitoring (BDM) host server 102, a payment card network server 104, a check processing network server 106, a broadband crowdsourcing server 107, a broadband network service data server 108, and a real property web service server 110 that are communicatively connected via a communications network 115. Although only one BDM host server 102 is shown in FIG. 1, additional BDM host servers may be deployed within system 100 without departing from the scope of the disclosed subject matter.

In some embodiments, communications network 115 includes a packet-based communications network (e.g., the Internet) that is utilized and/or accessed by servers 102-110 via a communications interface. Although a packet-based network is described for illustrative purposes, the subject matter described herein is not limited to a packet-based network. Any type of communications network through which messages can be exchanged electronically between computing platforms may be used without departing from the scope of the subject matter described herein. Such communications networks may include packet-based networks, circuit-switched networks, and combinations of packet-based and circuit-switched networks. Although not shown, each individual network entity (e.g., servers 102-110) associated with system 100 may reside in an individual (e.g., public or private) network, which may include a same network or different networks. Network 115 facilitates communication of data via packets or packet-based messages, which may be communicated between network entities according to any desired communication protocol as known in the art (e.g., IP, HTTP, TCP, UDP, SIP, or the like).

As indicated above, system 100 may include a BDM host server 102 that comprises a hardware based device configured to electronically determine actual broadband network service prices paid for a plurality of properties (e.g., different addresses or units/apartments at the same address) located at within a common designated geo-location. As shown in FIG. 1, BDM host server 102 may include a manager 112 and a report generator 114. Manager 112 may comprise a software module that is responsible for establishing communication with each of servers 104-110 in order to request and receive payment transaction data, broadband network service data, real property data, and the like. In some embodiments, manager 112 may facilitate the communication between BDM host server 102 and each of servers 104-110 via application programming interfaces (APIs) that are configured to electronically exchange messages via network 115. Further, manager 112 may also be configured to filter various forms of data acquired from servers 104-110 and subsequently utilize the filtered data to generate broadband transaction lists (as described below). Further, manager 112 may utilize the broadband transactions lists to generate a screen display (e.g., a visual representation) that graphically depicts the various degrees/levels of broadband network service availability and costs. Manager 112 may also utilize report generator 114 to create a broadband network service spend report that is based on information obtained from servers 108 and 110 (as described below). In some embodiments, manager 112 and report generator 114 may be stored in local memory of BDM host server 102 and are executed by at least one processor (not shown) in server 102.

As indicated above, BDM host server 102 (and/or manager 112) may establish communications with a payment card network by establishing communications with payment card network server 104. In some embodiments, payment card network server 104 is managed and operated by a payment card network entity (e.g., MasterCard® payment card network). Communications between server 102 and server 104 may be facilitated via messaging conducted by APIs supported on servers 102 and 104, respectively. Messaging may be performed using packet communications that traverse network 115. In some embodiments, payment card network server 104 is configured to host and/or store payment card transaction data that is managed and maintained by the payment card network. In some instances, such data may correspond to payments submitted by customers to broadband network service providers (e.g., satellite or cable broadband network service providers). For example, payment card transaction data may include payment card transaction records that include information such as, but not limited to, a customer location identifier, a merchant identifier (e.g., broadband network service provider identifier), and a payment transaction amount (e.g., a broadband network service payment amount, such as a broadband network service payment amount associated with the customer location identifier and/or broadband network service provider identifier). As used herein, a customer location identifier may include any identifier that specifies and/or is mapped with a customer geo-location, such as a street address, unit and/or apartment address, neighborhood, township, city, county, state, postal zip code (e.g., 72345), postal zip+4 code (e.g., 72345-9457), zoning district, and the like. In some embodiments, BDM host server 102 may obtain the payment transaction data, such as payment card transaction data, by requesting and/or “pulling” the payment transaction records via APIs in real-time. Alternatively, BDM host server 102 may download a raw feed file of payment transaction records from payment card network server 104. For example, the payment transaction data stored and obtained from payment card network server 104 may include payment transactions involving purchases of a plurality of different goods or services (e.g., all types and kinds of goods and services). Specifically, the payment transaction data may include payment transaction card data for both broadband network services and for goods and services other than broadband network services.

In some embodiments, BDM host server 102 may be provisioned with a geo-location prediction model algorithm that is configured to receive (as input) purchase transaction history data associated with an anonymous payment card holder and to subsequently determine an approximate geo-location with respect to that anonymous payment card holder (e.g., approximate location of residence). As an example, BDM host server 102 may receive purchase transaction records from payment card network server 104 and subsequently utilize the geo-location prediction model algorithm to derive a customer location identifier (e.g., a zip code, a zip +4 code, a county, city, etc.) that can identify the probable geo-location of the associated anonymous payment card holder.

In some embodiments, payment transaction data may also be obtained from a check processing network server 106. For example, communications between BDM host server 102 and check processing network server 106 may be facilitated via messaging conducted by APIs residing on servers 102 and 106, respectively. In other embodiments, BDM host server 102 may be configured download a raw feed file containing check payment data records from check processing network server 106. Messaging may be performed using packet communications that traverse network 115. In some embodiments, check processing network server 106 is configured to host and/or store check payment transaction data that is managed and maintained by the check processing network entity, such as an issuer entity and/or network. For example, issuer entities (such as a banking entity, a credit union entity, or other financial institution) are owners of the check payment data associated with the check payments made by the issuer entities' customers. Notably, an issuer entity that operates the check processing network server 106 may extract relevant information from checks, debit card, and/or check card transactions in order to generate check payment transaction records. In some embodiments, the check payment transaction records may include information such as, but not limited to, a customer location identifier, a broadband network service provider identifier, and a broadband network service payment amount. In some embodiments, the payment transaction data stored by check processing network server 106 may include payment transactions involving purchases of a plurality of different goods or services (e.g., all types and kinds of goods and services). Specifically, the payment transaction data may include check payment transaction data for both broadband network services and for goods and services other than broadband network services.

In some embodiments, payment transaction data may also be obtained from a broadband crowdsourcing server 107. For example, communications between BDM host server 102 and broadband crowdsourcing server 107 may be facilitated via messaging conducted by APIs residing on servers 102 and 107, respectively. In other embodiments, BDM host server 102 may be configured download a raw feed file containing crowdsourced payment data records from broadband crowdsourcing server 107. Messaging may be performed using packet communications that traverse network 115. In some embodiments, broadband crowdsourcing server 107 may be configured to receive and store broadband billing data that is submitted by existing customers of one or more broadband network service providers. For example, broadband crowdsourcing server 107 may store information including, but not limited to, broadband network service rates and/or payments, broadband network service tier information, reviews, support ratings, equipment photographs, and the like. The crowdsourced information stored by server 107 may be shared by customers and aggregated by BDM host server 102 with other source servers (e.g., a payment card network server 104, a check processing network server 106, a broadband network service data server 108, and a real property web service server 110, and the like).

In some embodiments, BDM host server 102 may be configured to employ an “opt-in” mechanism that enables users (e.g., payment card holders, crowdsourcing participants, etc.) to authorize BDM host server 102 to utilize the “opting in” user's customer location identifier information (e.g., general geo-location information, address information, demographic information, and/or any other personal data). More specifically, by “opting in”, a user provides BDM host server 102 permission to process user-specific information (albeit in an user-anonymous manner) for the generation of data pertaining to the identification of broadband network service costs and/or availability within a geo-location associated with the opted-in user.

System 100 further includes a broadband network service data server 108. In some embodiments, broadband network service data server 108 may comprise a national broadband network service map server (e.g., broadband.gov map server) that is responsible for hosting and/or storing broadband availability data for a number of geo-locations across the country. In some embodiments, broadband network service data server 108 may be configured to communicate with BDM host server 102 via APIs. Broadband network service data server 108 may further include a national broadband map database and associated software tools to search, analyze, and map broadband network service availability across the country. Exemplary data that is stored via broadband network service data server 108 includes, but not limited to, varying levels of broadband prices (e.g., an average price, a medium price, a minimum price, maximum price, etc.) associated with a customer location identifier (e.g., a particular property address). Broadband network service data server 108 may also include information regarding broadband retention (e.g., by location, by provider, wired vs. wireless, etc.), broadband availability and prices, and identifiers of service providers by bandwidth speed tier. In addition, broadband network service data server 108 also includes information regarding advertised speeds and the number of Internet providers per address in a particular geo-location. Further, broadband network service data server 108 may include information pertaining to the contract time/period of the broadband network service provider agreement. In some embodiments, broadband network service data server 108 may include a customer or payer identifier. Notably, all of the various types of information hosted by broadband network service data server 108 may be associated with a particular geo-location that is mapped to the customer location identifier.

In some embodiments, real property web service server 110 may be communicatively connected to BDM host server 102 via APIs. In some embodiments, real property web service server 110 comprises a Melissa Data® database server or a similar data entity. Notably, real property web service server 110 may be configured to store and/or provide valuable access to comprehensive property and mortgage data for a multitude of real estate records. Exemplary information stored by server 110 may include, but not limited to, owner and/or renter designation for a particular property address, household income, marital status, length of residence, number of persons in household, home value, property classification/designation (e.g., residential property vs. business property), and the like. Notably, all of the various types of information hosted by real property web service server 110 may be associated with a particular geo-location that is mapped to the customer location identifier.

In some embodiments, BDM host server 102 may receive payment transaction records from one or more of payment card network server 104, check processing network server 106, and broadband crowdsourcing server 107. In some embodiments, a payment transaction record may include at least a customer location identifier, an amount paid for broadband network services, and a broadband network service provider identifier. As previously indicated, the customer location identifier may comprise the address of the broadband network service customer, such as a street address of a building, or alternatively, further include the apartment or unit number of the property (e.g., apartment building or condominium) where the broadband network service is being provided.

In some embodiments, BDM host server 102 and/or manager 112 may be configured to initially collect and filter the payment transaction records received from payment card network server 104, check processing network server 106, and/or broadband crowdsourcing server 107. For example, BDM host server 102 may be configured to use one or more broadband network service provider identifiers as a filter or mask to identify the relevant transaction records (i.e., transaction records that include said one or more designated broadband network service provider identifiers). In some embodiments, manager 112 may be configured to cross-reference the payee identifiers included received payment transaction records with a listing of designated broadband network service provider identifiers. Notably, payment transaction records that include an identifier that matches a broadband network service provider identifier included in the listing is designated and/or filtered as a relevant payment transaction record for further processing by BDM host server 102.

As an example, after performing the filtering process, BDM host server 102 may utilize the filtered transaction records to determine a customer location identifier for the property (e.g., a street address), a broadband network service amount paid, and a broadband network service provider identifier for each of the filtered payment transaction records. BDM host server 102 may also utilize the filter transaction records to generate a broadband network service transaction list. In some embodiments, the broadband network service transaction list may include properties arranged by the customer location identifier. BDM host server 102 is further configured to determine the monetary amount paid (e.g., the broadband bill or invoice amount) for each of the broadband network services on the transaction list.

In some embodiments, BDM host server 102 may utilize report generator 114 to generate a broadband network service spend report. Notably, the broadband network service spend report may be based on the customer location identifiers (e.g., list of property addresses) included in the broadband transaction list and the processed broadband network service spend amount (and, optionally, the corresponding bandwidth/speed amounts of each broadband network service). Report generator 114 may be configured to generate a broadband network service spend report in accordance to a defined schedule (e.g., a periodic report) or, alternatively, in response to a report request (e.g., an ad hoc request, on demand, etc.) from a user and/or computing device via a web portal facilitated by APIs utilized by BDM host server 102 and/or report generator 114. In some embodiments, report generator 114 may generate the configurable broadband network service spend report that includes at least one of service levels, length of service, amounts paid, broadband devices, a payer identifier, a geographic region of the property, broadband network service location identifier for the residential property (e.g., a residential address including an alphanumeric identifier, such as street, unit number, postal zip code, zip+4 code, and/or the like), a broadband network service location identifier for the commercial property (e.g., a commercial address including an alphanumeric identifier, such as street, unit number, postal zip code, zip+4 code, and/or the like), a broadband network service provider identifier, an advertised service amount, an advertised broadband speed, broadband network service type (e.g., wired or wireless, such as cable service vs. satellite service) and a contract term or period of time. In some embodiments, the broadband network service spend report generated by report generator 114 may also provide a range of broadband network service amounts paid for the broadband network services, a change of broadband network service amounts that are paid over time for the broadband network service, a turnover rate for broadband network service customers delineated by broadband network service providers, broadband payment amounts for each of the plurality of broadband network service properties, and a variance between an advertised broadband network service amount and the broadband network service payment amount that is paid for the broadband network service property.

In some embodiments, manager 112 may obtain the above information by communicating a broadband network service data request message to broadband network service data server 108. In response, broadband network service data server 108 may extract the customer location identifier from the request message and use the customer location identifier to access relevant information stored in one or more databases. For example, the customer location identifier may be cross-referenced with other identifiers stored in the databases in order to obtain relevant broadband network service information associated with a geo-location that is mapped or identified by the customer location identifier. Broadband network service data server 108 may subsequently provide the acquired broadband network service data to BDM host server 102 via response message.

It will be appreciated that FIG. 1 is for illustrative purposes only and that various entities, their locations, and/or their functions described above in relation to FIG. 1 may be changed, altered, added, or removed.

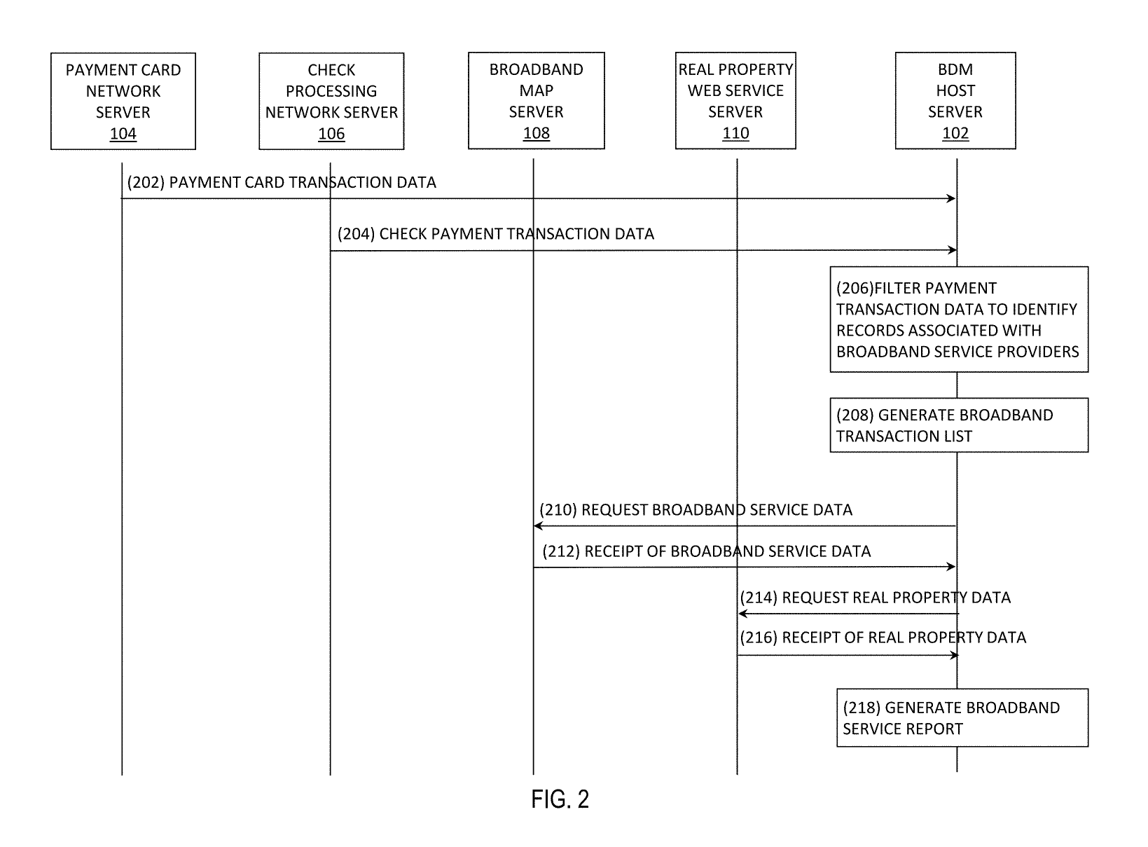

FIG. 2 is a diagram illustrating exemplary electronic messaging exchanged between various network entities for electronically determining broadband network service rates in a designated area according to an embodiment of the subject matter described herein. As shown in FIG. 2, the system entities associated with the disclosed subject matter include BDM host server 102, payment card network server 104, check processing network server 106, broadband crowdsourcing server 107, broadband network service data server 108, and real property web service server 110 (i.e., the same elements described above with regard to FIG. 1).

At line 202, payment transaction data is sent by a payment card network server. In some embodiments, a payment transaction data provisioning message is communicated from payment card network server 104 to BDM host server 102. The payment transaction data provisioning message may include information such as, but not limited to, a customer location identifier (e.g., the street/property address of the broadband network service customer), a payment amount (associated with the broadband network service), and a broadband network server provider identifier. In some embodiments, the payment transaction data comprises a plurality of payment transaction records. For example, the payment transaction data may be sent by payment card network server 104 in response to a request made by BDM host server 102. In some embodiments, the payment transaction data is communicated to BDM host server 102 via a packet-based network (e.g., the Internet).

At line 204, payment transaction data is sent by a check processing network server. In some embodiments, a payment transaction data provisioning message is communicated from check processing network server 106 to BDM host server 102. Similar to the payment transaction data sent by payment card network server 104, the payment transaction data provisioning message from check processing network server 106 may include payment transaction records that contain information included in processed checks such as, but not limited to, a customer location identifier (e.g., the address of the broadband network service customer), a payment amount (associated with the broadband network service), and a broadband network server provider identifier (i.e., the check payee name). In some embodiments, the payment transaction data may be sent by payment card network server 104 in response to a request made by BDM host server 102. In some embodiments, the payment transaction data is communicated to BDM host server 102 via a packet-based network (e.g., the Internet). Although not shown in FIG. 2, BDM host server 102 may also receive payment transaction data from broadband crowdsourcing server 107 in a manner similar to lines 202 and 204.

At block 206, a payment transaction data is filtered in order to identify payment transaction records associated with broadband network service providers. In some embodiments, BDM host server 102 utilizes a manager element (e.g., manager 112 in FIG. 1) to filter the transaction records received from both the payment card network server and the check processing network server (and/or data from broadband crowdsourcing server 107). Notably, the filtering process conducted by BDM host server 102 is used to determine which transaction records are related to payments for broadband network services. For example, BDM host server 102 may also process the filtered transaction data to determine a customer location identifier for a particular property, a broadband network service amount, and a broadband network service provider identifier.

At block 208, a broadband transaction list of properties is generated. In some embodiments, BDM host server 102 may be configured to generate the broadband transaction list of properties based on a customer location identifier (e.g., street address, apartment and/or unit number, etc.). Each of the entries of the transaction list may also include a monetary amount paid (for the broadband network services provided to each geo-location.

In line 210, a request for broadband network service provider data is sent. In some embodiments, BDM host server 102 sends a request message to broadband network service data server 108. For example, the request message may include a customer location identifier that may be used by broadband network service data server 108 to obtain broadband network service provider data that corresponds to the geo-location associated with the customer location identifier. In some embodiments, broadband network service data server 108 responds with a message (line 212) containing broadband network service provider data such as, bandwidth speed levels, length of service, payment amounts, and broadband devices associated with each of a plurality of addresses in the particular geo-location.

Similarly, in line 214, a real property data request is sent by BDM host server 102. In some embodiments, BDM host server 102 sends the request message for real property data to real property web service server 110. For example, the request message may include a customer location identified that may be used by broadband network service data server 108 to obtain real property data that corresponds to the geo-location specified by the customer location identifier. In response to the request, real property web service server 110 sends the requested real property data to BDM host server 102. In some embodiments, real property web service server 110 responds with a message (line 216) containing real property web service data such as, demographic data (e.g., property is designated as a residential property or business property location) associated with each of a plurality of addresses in the particular geo-location.

At line 218, in addition, a broadband network service spend report is generated. In some embodiments, the broadband network service spend report is generated by BDM host server 102. In particular, BDM host server utilizes the received broadband network service provider data and real property data to generate the broadband network service spend report.

It will be appreciated that FIG. 2 is for illustrative purposes only and that various messages, message sequencing and/or message content described above in relation to FIG. 2 may be changed, altered, edited, or removed where necessary. For example, some messages may be separated or combined into more than one or less than one message.

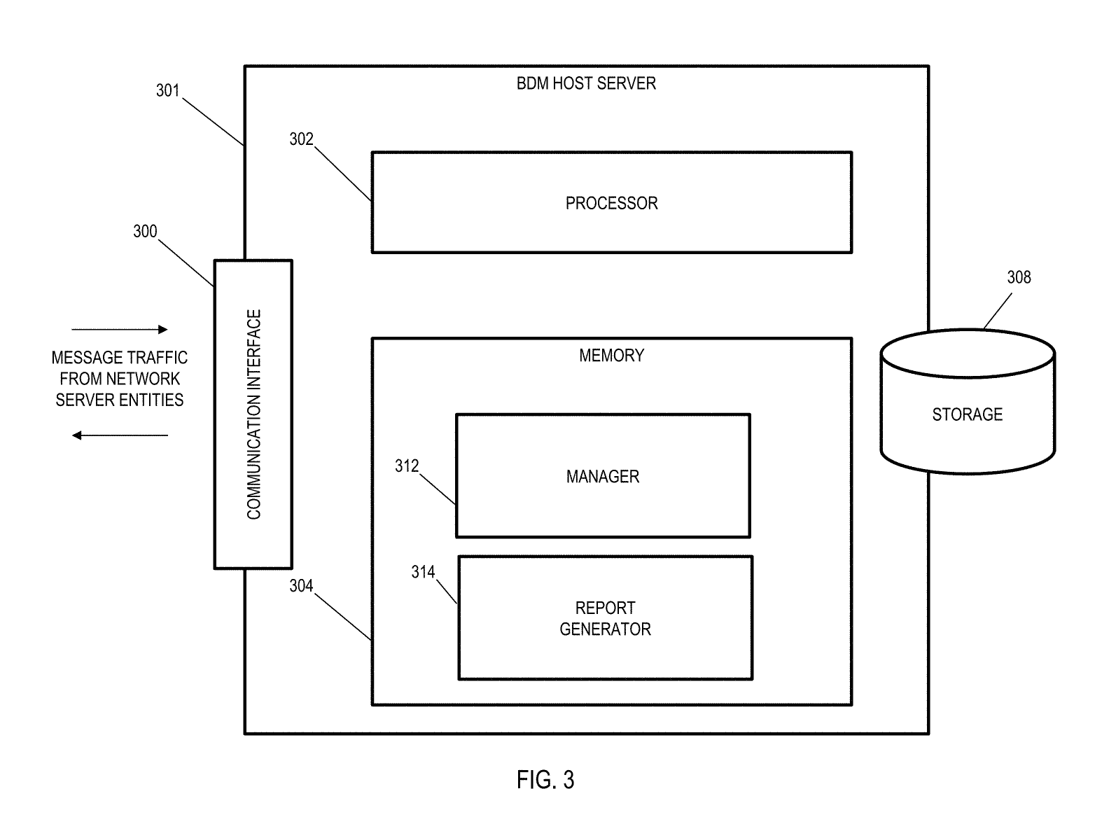

FIG. 3 is a block diagram illustrating an exemplary special purpose machine or device for electronically determining broadband network service rates in a designated area according to an embodiment of the subject matter described herein. FIG. 3 illustrates BDM host server 301, which includes at least one communication interface 300, at least one processor 302, and at least one memory 304 (e.g., a memory component, element or device). In some embodiments, BDM host server 301 includes a manager 312 stored in memory 304 and is configured to utilize interface 300, processor 302, and memory 304 for executing an algorithm to communicate information (e.g., via an API-API exchange) with other network entities (e.g., servers 104-110 in FIG. 1) to facilitate the electronic determination of broadband network service rates in a designated area. In some embodiments, packets or message traffic (e.g., payment transaction data requests and responses, broadband network service provider data requests and responses, real property data requests and responses, and/or the like) is sent, received, and/or otherwise communicated or exchanged between manager 312 and other network entities via communication interface 300. Although only one communications interface 300 is illustrated in FIG. 3, one or more additional communications interfaces may be provided whereby connections to a packet network (e.g., network 115 as shown in FIG. 1) and other entities are established. That is, communications interface 300 may include an interface by which packet data messages are received, sent, and/or exchanged.

In some embodiments, communications interface 300 is utilized by manager 312 to transfer and exchange any messaging information (e.g., payment transaction data, broadband network service data, real property data, etc.) by which manager 312 can use to generate reports and/or visual representations of availability and price point of the broadband network service. Manager 312 is further configured to receive payment transaction data used to electronically determine the broadband network service rates in a designated area.

In some embodiments, processor 302 includes a microprocessor, such as a central processing unit (CPU), or any other hardware-based processor unit. Processor 302 is configured to execute and/or utilize software to communicate with network servers (e.g., servers 104-110 as shown in FIG. 1) and any platforms associated therewith, for electronically determining broadband network service rates in a designated area.

In some embodiments, manager 312 may comprise a module that is executed by processor 302 and stored in memory 304. Manager 312 may include hardware, software and/or firmware components for implementing the electronically determination of broadband network service rates in a designated area as described herein. In one exemplary implementation, manager 312 includes functionality for receiving payment transaction data, broadband network service provider data, and/or real property data, and the like. Storage 308 can comprise any type of storage element, component, or device, not limited to a database, a data table, a cache, a storage drive, or any other collection of records or information including the received payment transaction data, broadband network service data, and real property data.

In some embodiments, manager 312 includes functionality for reading, parsing, and/or otherwise processing APIs to electronically determine broadband network service rates in a designated area. Notably, manager 312 is configured to support various APIs and communicate with each of servers 104-110 to receive, request, and/or obtain/pull data.

In some embodiments, memory 304 (e.g., a memory element or device) of manager 312 includes a random access memory (RAM), a read only memory (ROM), an optical read/write memory, a cache memory, a magnetic read/write memory, a flash memory, or any other non-transitory storage media. In some embodiment, processor 302 and memory 304 may be used to execute and manage the operation of manager 312. In some embodiments, memory 304 and/or storage 308 include any medium that is configured to locally store payment transaction data, broadband network service data, and real property data used to determine actual broadband network service rates present in a designated area.

Although FIG. 3 depicts BDM host server 301 as a single node or network element, BDM host server 301 may alternatively comprise a plurality of network elements or components without departing from the scope of the present subject matter. BDM host server 301 may include multiple processors, memory elements, interfaces, or the like. Notably, BDM host server 301 is a special purpose computing device or machine having hardware components (e.g., one or more processor units, memory, and network interfaces) configured to execute hardware and software elements (e.g., APIs, packets, modules, etc.) for the purposes of performing one or more aspects of the disclosed subject matter. In addition, it should be noted that BDM host server 301 and the components or functionality thereof constitute special purpose computers that improve the technological field pertaining to broadband network service assessment. For example, the present subject matter may afford technical advantages to service provider advisors and/or customer users alike by identifying favorable service areas, providing improved broadband network service management, and identifying marketing opportunities.

It will be appreciated that FIG. 3 is for illustrative purposes only and that various components, their locations, and/or their functions described above in relation to FIG. 3 may be changed, altered, added, integrated, segregated, or removed. For example, some components and/or functions may be separated or combined into more than one entity.

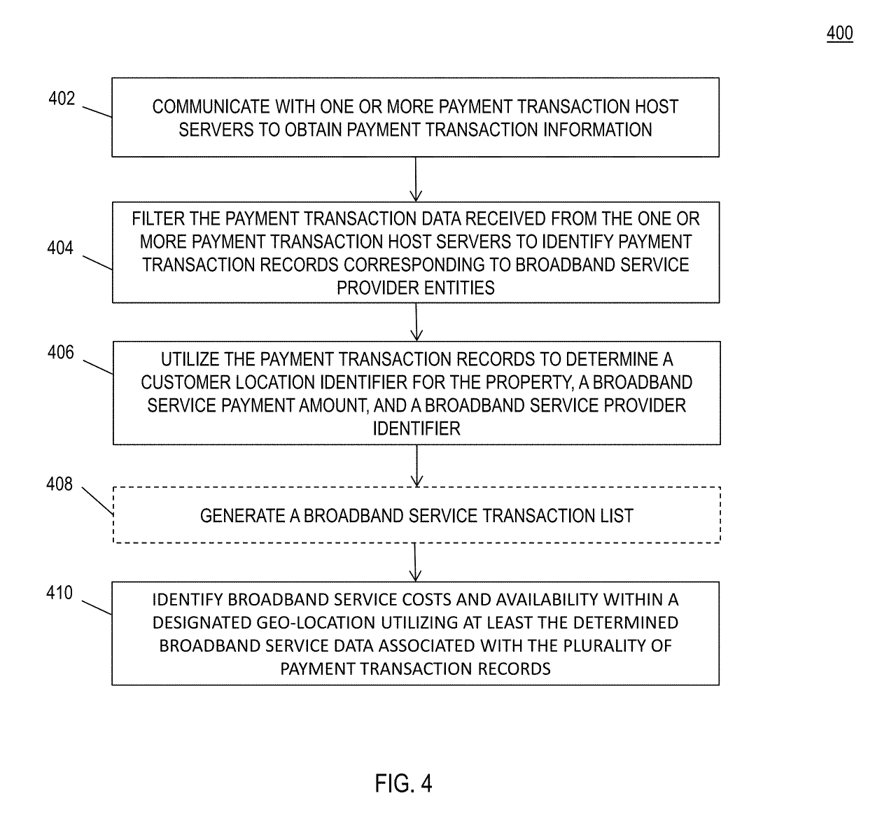

FIG. 4 is a diagram illustrating an exemplary method 400 for electronically determining broadband network service rates in a designated area according to an embodiment of the subject matter described herein.

In block 402, communication with one or more payment transaction host servers is conducted to obtain payment transaction information regarding payment transactions involving purchases of a plurality of different goods or services, wherein the payment transaction data includes payment transaction data for broadband network services and for goods and services other than broadband network services. In some embodiments, the BDM host server is provided (e.g., delivered on a periodic basis or upon request by the BDM host server) with payment transaction data from at least one of a payment card network server and/or a check processing network server. More specifically, the BDM host server may receive at least one of payment card transaction data from the payment card network server and check transaction data from the check processing network server.

For example, BDM host server 102 (and/or manager 112) and payment card network server 104 communicate and/or exchange message requests and control messages via APIs configured to facilitate the communication of data and messages. Communications exchanged between BDM host server 102 and server 104 (as well as check processing network server 106 and/or broadband crowdsourcing server 107) may include packets having payload data containing payment transaction information. In some embodiments, the payment transaction information may include customer identity information (e.g., customer name, a customer personal account number (PAN), or any other a unique customer identifier number). Alternatively, the payment transaction data obtained by BDM host server 102 may include a customer location identifier (e.g., a street address, a postal zip code, zip+4 code, etc. or a geo-location identifier that is mapped/coded to such real world locations/areas) without any association to a customer's personal identity or account (i.e., in order to keep customer identity anonymous).

In block 404, the payment transaction data received from the one or more payment transaction host servers is filtered to identify payment transaction records corresponding to broadband network service provider entities. In some embodiments, the BDM host server may be configured to process payment transaction data to identify transaction data records that are associated with a broadband network service provider. For example, the BDM host server may utilize a designated white list containing broadband network service provider identifiers that may be compared to payee identifiers included in the payment transaction records.

In block 406, payment transaction records are utilized to determine a customer location identifier for the geo-location, a broadband network service payment amount, and a broadband network service provider identifier. In some embodiments, BDM host server is configured to process the filtered payment transaction records to identify the customer location identifier, a broadband network service payment amount, and a broadband network service provider identifier.

In optional block 408, a broadband network service transaction list is generated. In some embodiments, the BDM host server utilizes the filter data to generate a broadband network service transaction list. Notably, each entry of the broadband network service transaction list includes a property address and associated actual broadband network service payment amount and broadband speed level information. In some embodiments, the broadband transaction report may also include information pertaining to broadband device identifiers, a geographic region of the property, a broadband location identifier for the residential property, a broadband network service provider identifier, an advertised service amount, advertised broadband speed, and/or a contract term/period. Further, the broadband network service spend report may also provide a range of broadband amounts paid for the broadband network services, a change of broadband amounts paid over time for the broadband network service, and turnover rate for broadband customers. Notably, this type of information may be obtained from a broadband network service data server. In addition, the data may be filtered and/or segregated by customer location identifier (e.g., individual addresses) for aggregation into a single report for all addresses within a single building street address.

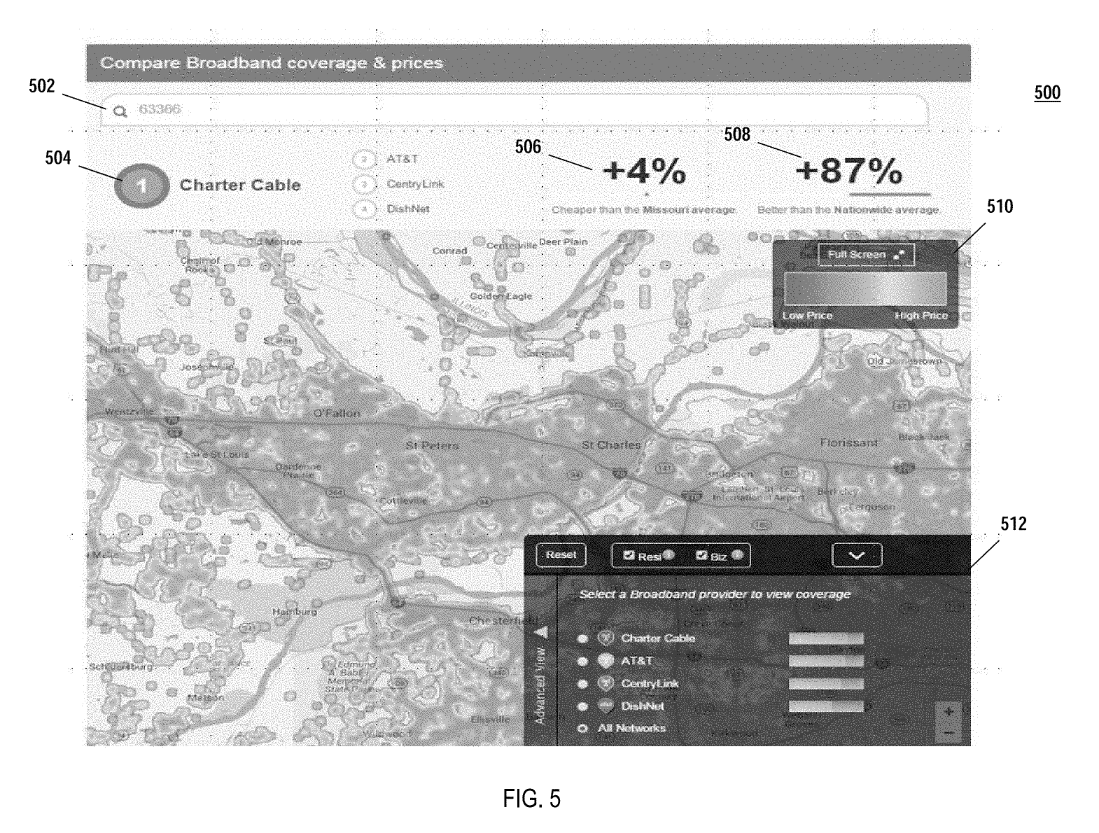

In block 410, broadband network service costs and availability within a designated geo-location are identified utilizing at least the determined broadband network service data associated with the plurality of payment transaction records. In some embodiments, the BDM host server may be configured to generate a visual representation, such as a heat map display (as described below in FIG. 5) that graphically illustrates the varying levels of broadband network service availability and broadband network service costs in a designated geo-location (e.g., a neighborhood or county).

It will be appreciated that exemplary method 400 is for illustrative purposes only and that different and/or additional actions may be used. It will also be appreciated that various actions associated with exemplary method 400 may occur in a different order or sequence.

FIG. 5 depicts an exemplary user interface graphical display 500 that may be used to determine broadband network service rates in a designated area the disclosed subject matter. In some embodiments, display 500 comprises a dynamic map that depicts the broadband network service coverage and price point rates associated with a designated geo-location. For example, manager 112 in BDM host server 102 (as depicted in FIG. 1) may be configured to host and/or execute the software (e.g., stored in memory) needed to generate and/or support display 500. In some embodiments, display 500 may include a search bar UI element 502 that can be used by a user to select and/or designate a particular geo-location (e.g., city, state, zip code, zip+4 code, etc.) that is visually represented by display 500 (e.g., a display of a broadband network service map area). Display 500 further includes a section 504 that may display the top (e.g., most popular, servicing the most subscribers, etc.) broadband network service providers within the displayed map area. Display 500 may further include sections 506 and 508, which respectively display the average bill amount of the designated geo-location in comparison to the rest of the state and the average billed comparison of the designated geo-location to the rest of the country. Display 500 may further include a legend 510, which indicates various colors/shades to visually display varying price point levels in the designated geo-location. Display 500 may further include a user interface panel 512, which comprises several graphical control elements. For example, user interface panel 512 may include a graphical control element 514 (e.g., checkboxes) to select the representation of at least one of residential and/or business entities to be considered on display 500. Further, user interface panel 512 also includes a graphical control element 516 (e.g., UI “radio” buttons) to select one or more service providers for the area. Lastly, user interface panel 512 may include one or more advanced view options with filters. For example the advanced view options may enable i) deeper depth dives into pricing levels by a service provider, ii) customer loyalty data (for example, “X” number of months average retention), iii) price fluctuation data, and iv) date selection for legacy data and trending information.

In some embodiments, BDM host server 102 utilizes payment transaction data, broadband network service availability data, and real property data obtained from servers 104-110 to derive the data points required to generate one or more UI elements or aspects of display 500. For example, BDM host server 102 may be configured to process payment transaction data (e.g., payment card transaction data and check payment transaction data) that is made available from servers 104-106 in order to determine and model actual broadband network service price points. In particular, actual broadband network service price point data for a given geo-location may be derived from payment transaction data corresponding to the geo-location itself (e.g., mapping the check or payment card payment amounts to the property address of the service user). BDM host server 102 may then utilize the payment transaction data and the corresponding customer location information (e.g., geo-location and/or property address) to generate a broadband network service data point. In some embodiments, BDM host server may graphically represent the broadband network service data point via a visual representation (e.g., a heat map display). Further, data obtained from servers 106-110 may also be used to generate other UI elements of display 500.

It will be understood that various details of the subject matter described herein may be changed without departing from the scope of the subject matter described herein. Furthermore, the foregoing description is for the purpose of illustration only, and not for the purpose of limitation. For example, various combinations and sub-combinations of the structures and features described herein are contemplated, and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method comprising:
filtering payment transaction data received from one or more payment transaction host servers to identify a plurality of payment transaction records corresponding to broadband network service provider entities;
determining, for each of the plurality of payment transaction records, broadband network service data including a customer location identifier, a broadband network service payment amount, and a broadband network service provider identifier;
identifying broadband network service costs and availability within a designated geo-location utilizing at least the determined broadband network service data associated with the plurality of payment transaction records; and
generating, and presenting, via a graphical user interface, a visual representation that indicates the broadband network service costs and availability within the designated geo-location.

2. The method of claim 1 wherein determining broadband network service data comprises generating a broadband network service transaction list that includes entries, wherein each of the entries contains a customer location identifier and an associated broadband network service payment amount.

3. The method of claim 1 wherein the one or more payment transaction host servers includes at least one of a payment card network server, a check processing network server, or a broadband crowdsourcing server.

4. The method of claim 1 wherein the customer location identifier includes at least a residential address or a commercial address of a broadband network service customer.

5. The method of claim 1 wherein identifying the broadband network service cost and availability includes requesting real property web service data and broadband network service data associated with the customer location identifier.

6. The method of claim 1 wherein filtering the filtering the payment transaction data includes utilizing a designated white list containing broadband network service provider identifiers that may be compared to payee identifiers included in the payment transaction records.

7. The method of claim 1 wherein the visual representation comprises a heat map that displays varying broadband network service rates that are set by broadband network service providers within the designated geo-location.

8. A system comprising:
one or more payment transaction host servers configured to store payment transaction data; and
a broadband data monitoring (BDM) host server configured to communicate with one or more of the payment transaction host servers to obtain the payment transaction data, to filter the payment transaction data received from the one or more payment transaction host servers to identify a plurality of payment transaction records corresponding to broadband network service provider entities, determine, for each of the plurality of payment transaction records, broadband network service data including a customer location identifier, a broadband network service payment amount, and a broadband network service provider identifier, to identify broadband network service costs and availability within a designated geo-location utilizing at least the determined broadband network service data associated with the plurality of payment transaction records, and to generate, and to present, via a graphical user interface, a visual representation that indicates the broadband network service costs and availability within the designated geo-location.

9. The system of claim 8 wherein the BDM host server is configured to a broadband network service transaction list that includes entries, wherein each of the entries contains a customer location identifier and an associated broadband network service payment amount.

10. The system of claim 8 wherein the one or more payment transaction host servers includes at least one of a payment card network server, a check processing network server, or a broadband crowdsourcing server.

11. The system of claim 8 wherein the customer location identifier includes at least a residential address or a commercial address of a broadband network service customer.

12. The system of claim 8 wherein the BDM host server is configured to request real property web service data and broadband network service data associated with the customer location identifier.

13. The system of claim 8 wherein filtering the payment transaction data includes utilizing a designated white list containing broadband network service provider identifiers that may be compared to payee identifiers included in the payment transaction records.

14. The system of claim 8 wherein the visual representation comprises a heat map that displays varying broadband network service rates that are set by broadband network service providers within the designated geo-location.

15. A non-transitory computer readable medium having stored thereon executable instructions that when executed by a processor of a computer control the computer to perform steps comprising:
filtering payment transaction data received from the one or more payment transaction host servers to identify a plurality of payment transaction records corresponding to broadband network service provider entities;
determining, for each of the plurality of payment transaction records, broadband network service data including a customer location identifier, a broadband network service payment amount, and a broadband network service provider identifier;
identifying broadband network service costs and availability within a designated geo-location utilizing at least the determined broadband network service data associated with the plurality of payment transaction records; and
generating, and presenting, via a graphical user interface, a visual representation that indicates the broadband network service costs and availability within the designated geo-location.

16. The non-transitory computer readable medium of claim 15 wherein determining broadband network service data comprises generating a broadband network service transaction list that includes entries, wherein each of the entries contains a customer location identifier and an associated broadband network service payment amount.

17. The non-transitory computer readable medium of claim 15 wherein the one or more payment transaction host servers includes at least one of a payment card network server, a check processing network server, or a broadband crowdsourcing server.

18. The non-transitory computer readable medium of claim 15 wherein the customer location identifier includes at least a residential address or a commercial address of a broadband network service customer.

19. The non-transitory computer readable medium of claim 15 wherein identifying the broadband network service cost and availability includes requesting real property web service data and broadband network service data associated with the customer location identifier.

20. The non-transitory computer readable medium of claim 15 wherein the visual representation comprises a heat map that displays varying broadband network service rates that are set by broadband network service providers within the designated geo-location.
